(19) United States
(12) Patent Application Publication
(10) Pub. No.: US 2016/0161754 A1
(43) Pub. Date: Jun. 9, 2016

(54) DISPLAY DEVICE

(71) Applicant: Japan Display Inc., Tokyo (JP)

(72) Inventors: Yosuke HYODO, Tokyo (JP); Shinichiro OKA, Tokyo (JP)

(21) Appl. No.: 14/962,450

(22) Filed: Dec. 8, 2015

(30) Foreign Application Priority Data
Dec. 9, 2014 (JP) 2014-248943

(51) Int. Cl. G02B 27/22; G02F 1/29

(52) U.S. Cl. CPC G02B 27/2214; G02F 1/29

(57) ABSTRACT

A display device having a liquid crystal parallax barrier panel arranged on a display panel, wherein pixels are arrayed at a pitch p1 in a first direction and are arrayed at a pitch p2 in a second direction on the display panel, the parallax barrier is configured such that liquid crystal is sandwiched between a first substrate on which an electrode is formed in a plane state and a second substrate on which barrier electrodes extending in the first direction and arrayed at a pitch p3 in the second direction are formed, p2>2p3, the barrier electrode extends in the first direction while repeatedly bending at a wave height h and a pitch pw, and with respect to a first pitch p1 of the pixels, a pitch of the barrier electrodes corresponds in terms of npw (n is an integer number).

### CLAIM OF PRIORITY

The present application claims priority from Japanese Patent Application JP 2014-248943 filed on Dec. 9, 2014, the content of which is hereby incorporated by reference into this application.

### BACKGROUND OF THE INVENTION

1. Field of the Invention

The present invention relates to a display device and more specifically to a three-dimensional display device using a parallax barrier panel provided by liquid crystal or a liquid crystal lens.

2. Description of Related Arts

Known as a method of displaying a three-dimensional image without use of glasses is a parallax barrier system. The parallax barrier system is a method of setting, behind a plate (called a parallax barrier panel) with a plurality of thin vertical slits, an image obtained by alternately arranging an image in a visual field from a right eye and an image in a visual field from a left eye for the purpose of cutting them into vertical strips of paper and then displaying this image three-dimensionally via a parallax barrier. Liquid crystal can be used to form the parallax barrier.

On the other hand, a lens can be formed by use of anisotropy of a refractive index of liquid crystal molecules. Pixels for the right eye and pixels for the left eye can be separated from each other by this liquid crystal lens to thereby form a three-dimensional image.

Described in Japanese Patent Application Laid-open No. 2013-92607 is configuration of a three-dimensional display device using a parallax barrier using liquid crystal or a liquid crystal lens such that electrodes of the parallax barrier or electrodes of the liquid crystal lens are bent for the purpose of preventing moire appearing on a three-dimensional image.

Described in Japanese Patent Application Laid-open No. 2009-216990 is configuration such that, for the purpose of reducing moire between a light-diffusing layer of a stripe structure arranged on a front surface of a liquid crystal display panel and a pixel row of the liquid crystal display panel, the pixel row is cyclically bent.

### CONVENTIONAL ART LITERATURES

### Patent Literatures

[Patent Literature 1] Japanese Patent Application Laid-open No. 2013-92607

[Patent Literature 2] Japanese Patent Application Laid-open No. 2009-216990

The parallax barrier panel using liquid crystal or the liquid crystal lens has an advantage that a two-dimensional image and a three-dimensional image can easily be switched when needed. Specifically, in case of the parallax barrier panel, forming a barrier pattern by applying a barrier signal to a barrier electrode permits three-dimensional display, and in a case where no barrier signal is applied to the parallax barrier panel, two-dimensional display can be performed. Moreover, in case of the liquid crystal lens, voltage application to a lens forming electrode forms a lens, resulting in three-dimensional display, while no voltage application to the lens forming electrode permits two-dimensional display.

### SUMMARY OF THE INVENTION

The barrier electrode for barrier formation and the liquid crystal lens forming electrode for the liquid crystal lens are formed by a transparent electrode of, for example, indium tin oxide (ITO). Both the barrier electrode and the liquid crystal lens forming electrode are formed periodically, and thus interference with, for example, a black matrix formed on the liquid crystal display panel occurs, which contributes to moire. It is an object of the invention to take countermeasures against the moire appearing at time of two-dimensional display in the parallax barrier or the liquid crystal lens.

The present invention solves the problem as described above, and detailed main means for solving the problem are as follows.

(1) A display device having a liquid crystal parallax barrier panel arranged on a display panel, wherein pixels are arrayed at a pitch p1 in a first direction and are arrayed at a pitch p2 in a second direction on the display panel, the parallax barrier is configured such that liquid crystal is sandwiched between a first substrate on which an electrode is formed in a plane state and a second substrate on which barrier electrodes extending in the first direction and arrayed at a pitch p3 in the second direction are formed, p2>2p3, the barrier electrode extends in the first direction while repeatedly bending at a wave height h and a pitch pw, and with respect to a first pitch p1 of the pixels, a pitch of the barrier electrodes corresponds in terms of npw (n is an integer number).
(2) A display device having a liquid crystal lens arranged on a display panel, wherein pixels are arrayed at a pitch p1 in a first direction and are arrayed at a pitch p2 in a second direction on the display panel, the liquid crystal lens is configured such that liquid crystal is sandwiched between a first substrate on which a first electrode is formed in a plane state and a second substrate on which second electrodes extending in the first direction and arrayed at a pitch p3 in the second direction are formed, p2>2p3, the second electrode extends in the first direction while repeatedly bending at a wave height h and a pitch pw, and with respect to a first pitch p1 of the pixels, a pitch of the second electrodes corresponds in terms of npw (n is an integer number).

### BRIEF DESCRIPTION OF THE DRAWINGS

FIG. 1 is a sectional pattern diagram of a three-dimensional image display device adopting a parallax barrier system according to the present invention;

FIG. 2 is a sectional pattern diagram showing principles of the parallax barrier system;

FIG. 3A is a sectional diagram of a parallax barrier panel showing a state in which the barrier panel is OFF;

FIG. 3B is a sectional diagram of the parallax barrier panel showing a state in which the barrier panel is ON;

FIG. 4 is a pattern diagram showing an eye tracking system;

FIG. 5A is a sectional pattern diagram where a barrier region is at a first position;

FIG. 5B is a sectional pattern diagram showing a state in which the barrier region is moved rightward;

FIG. 5C is a sectional pattern diagram showing a state in which the barrier region is further moved rightward;

FIG. 6 is a sectional diagram showing configuration such that barrier electrodes are divided to form a barrier;

FIG. 7 shows an example of a plan diagram of the barrier electrodes;

FIG. 8 shows an example of a plan diagram of pixels;

FIG. 9 shows an example of a plan diagram of the barrier electrodes according to the invention;

FIG. 10 is a detailed plan diagram of the barrier electrode according to the present invention;

FIG. 11 is a graph showing a state of moire in a case where a bending pitch of the barrier electrode is constant and a crest value thereof is varied;

FIG. 12 is a graph showing a state of moire in a case where the crest value of the barrier electrode is constant and the bending pitch thereof is varied;

FIG. 13 is a pattern diagram showing a problem of a parallax barrier in a case where a visual distance from a screen is increased;

FIG. 14 is a pattern diagram showing rainbow-colored unevenness appearing on the screen in a case where the visual distance from the screen is increased;

FIG. 15 shows a barrier electrode pattern causing the appearance of the rainbow-colored unevenness on the screen in the case where the visual distance from the screen is increased;

FIG. 16 shows a barrier electrode pattern as countermeasures against the rainbow-colored unevenness appearing on the screen in the case where the visual distance from the screen is increased;

FIG. 17 is a plan diagram showing relationship between pixels and the barrier electrode pattern indicating a problem of the pattern in FIG. 16;

FIG. 18 is a pattern diagram showing horizontally-lined unevenness in the case where the visual distance from the screen is increased;

FIG. 19 is a plan view showing relationship between the barrier electrodes and the pixels according to the present invention;

FIG. 20 is another plan diagram showing relationship between the barrier electrodes and the pixels according to the invention;

FIG. 21 is a plan diagram showing another shape of the barrier electrode according to the invention;

FIG. 22 is a plan diagram showing still another shape of the barrier electrode according to the invention;

FIG. 23 is a plan diagram showing still another shape of the barrier electrode according to the invention;

FIG. 24 is a sectional pattern diagram of a three-dimensional display device using a liquid crystal lens;

FIG. 25 is a plan diagram of a first substrate of the liquid crystal lens;

FIG. 26 is a plan view of a second substrate of the liquid crystal lens;

FIG. 27 is a sectional diagram showing a state of the liquid crystal lens when it is OFF;

FIG. 28 is a sectional view showing a state of the liquid crystal lens when it is ON;

FIG. 29 is a pattern diagram showing principles of the liquid crystal lens;

FIG. 30 is a pattern diagram showing operation of the liquid crystal lens;

FIG. 31 is a pattern diagram showing movement of the lens when human eyes move;

FIG. 32 shows an example of a second electrode capable of moving the liquid crystal lens;

FIG. 33 is a sectional diagram showing voltage application when the liquid crystal lens is moved;

FIG. 34 is a pattern diagram showing an eye tracking system in a liquid crystal lens system;

FIG. 35 is a plan diagram showing a shape of a second electrode in the liquid crystal lens;

FIG. 36 is a plan diagram showing another shape of the second electrode in the liquid crystal lens;

FIG. 37 is a plan diagram showing still another shape of the second electrode in the liquid crystal lens; and

FIG. 38 is a plan diagram showing still another shape of the second electrode in the liquid crystal lens;

### DETAILED DESCRIPTION OF THE PREFERRED EMBODIMENTS

In the first embodiment below, the invention will be described referring to a three-dimensional display method in a parallax barrier system, and in the second embodiment, the invention will be described referring to a three-dimensional display method in a liquid crystal lens system.

### First Embodiment

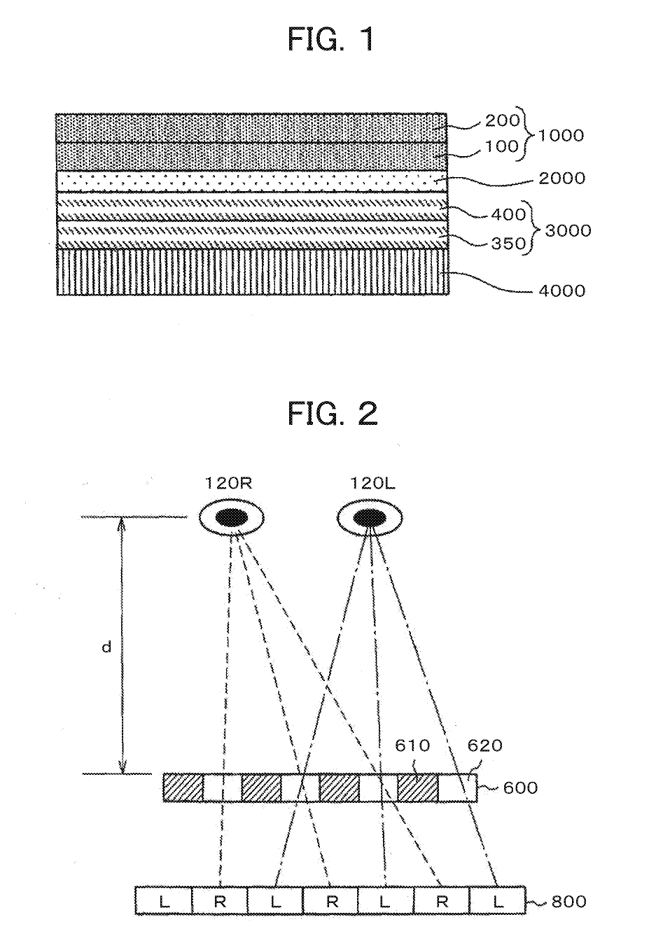

FIG. 1 is a sectional pattern diagram of a three-dimensional image display device according to the invention. The device shown in FIG. 1 is so configured as to be capable of viewing, as a three-dimensional image by using a liquid crystal parallax barrier panel 1000, an image formed by a liquid crystal display panel 3000. The liquid crystal parallax barrier panel (hereinafter referred to as parallax barrier panel) 1000 and the liquid crystal display panel 3000 are bonded together with a transparent bonding member 2000.

The liquid crystal display panel is formed by attaching together a TFT substrate 350 in which pixels having a TFT and a pixel electrode are formed in a matrix form and an opposite substrate 400 with a sealing member, and then sealing liquid crystal therein. On the TFT substrate 350, a scan line extends in a first direction and is arrayed in a second direction, and a video signal line extends in the second direction and is arrayed in the first direction. A portion surrounded by the scan line and the video signal line forms a pixel. In this case, red pixels, green pixels, and blue pixels are arrayed in the first direction. On the opposite substrate 400, a black matrix is formed at a portion corresponding to a source electrode or the video signal line of the TFT substrate 350, achieving an improvement in screen contrast.

A liquid crystal display device does not emit light by itself, and thus a back light 4000 is arranged on a rear surface of the liquid crystal display panel 3000. The back light 4000 has optical components including: in addition to a light source, for example, a light guide plate, a diffusing plate, and in some cases, a prism sheet for improving light use efficiency.

FIG. 2 is a sectional view showing principles of three-dimensional image display in the parallax barrier system. By barrier regions 610 and opening regions 620 formed on a barrier pattern 600, the right eye recognizes only images R for the right eye formed on a display device 800, and the left eye recognizes only images L for the left eye, thereby permitting a human being to recognize a three-dimensional image.

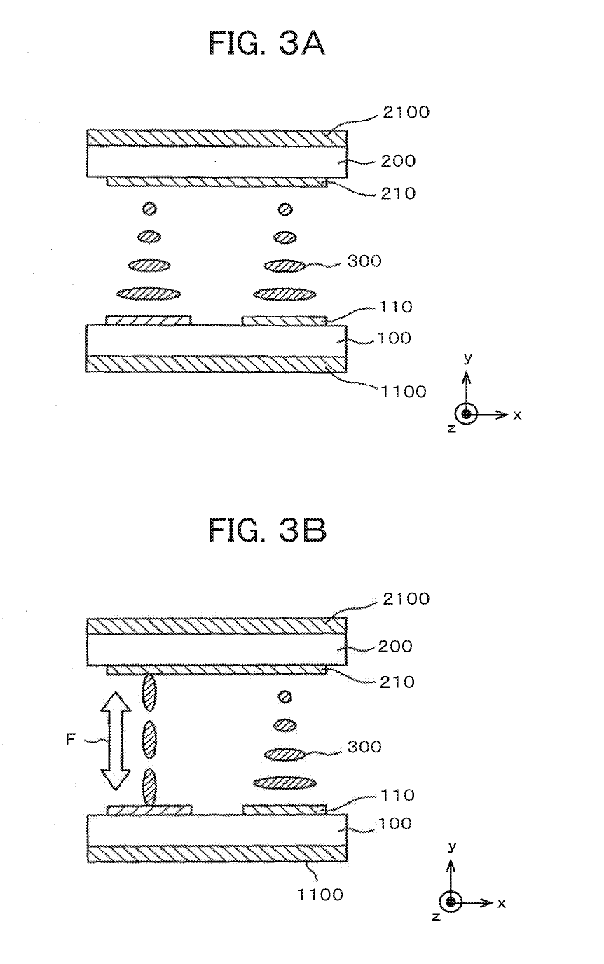

FIGS. 3A and 3B are sectional diagrams showing operation principles of the liquid crystal parallax barrier panel. Both FIGS. 3A and 3B show a liquid crystal panel in a twisted nematic (TN) system. In FIG. 3A, a common electrode 210 is formed on an entire surface of a common substrate 200 in a plane state, and barrier electrodes 110 of a stripe shape extend at predetermined pitches in a direction perpendicular to a paper. surface. FIG. 3A shows a state in which no voltage is applied between the common electrode 210 and the barrier electrodes 110, in which light from the liquid crystal display panel is not subjected to modulation. Therefore, in this case, tow-dimensional pixels are displayed.

FIG. 3B shows a case where voltage is applied to every other barrier electrode 110 of the same parallax barrier panel. In a region where the voltage is applied to the barrier electrode 110, light is blocked, and through a region where no voltage is applied to the barrier electrode 110, light is transmitted. As a result, viewing from a main surface of the parallax barrier panel, the light-blocking region of a stripe shape and the opening region of a stripe shape appear to be formed alternately. In FIG. 3B, an arrow F shows an electric field.

To express a complete three-dimensional image, as shown in FIG. 2, the parallax barrier system requires fixation of the human eyes at a given position. Lateral movement of the human eyes cause the pixels, which are originally supposed to be recognized by the left eye only, to be also recognized by the right eye, or the pixels, which are originally supposed to be recognized by the right eye only, to be also recognized by the left eye. This is called cross talk, which deteriorates quality of the three-dimensional image.

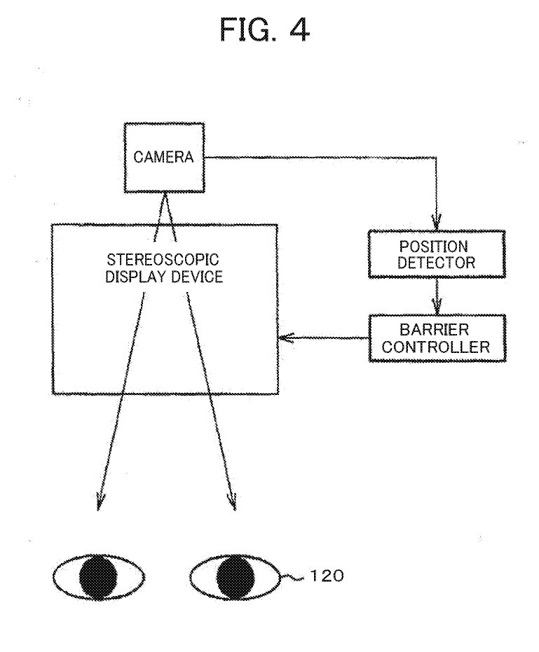

To avoid this, there is a system of moving the position of the barrier in accordance with the human eyes. FIG. 4 is a block diagram showing a system of feeding back this data to a display device. Hereinafter, this system is called an eye tracking system. In FIG. 4, the position of the human eyes 120 is measured with the camera. For this camera, use of a photographic camera in, for example, a mobile phone without use of a dedicated camera permits application of this system.

In FIG. 4, the position of the human eyes 120 detected with the camera is inputted to a position detector, from which this signal is inputted to a barrier controller. The barrier controller creates a signal for controlling a position of the barrier pattern on the barrier substrate, and inputs this signal to a three-dimensional display device having a parallax barrier panel.

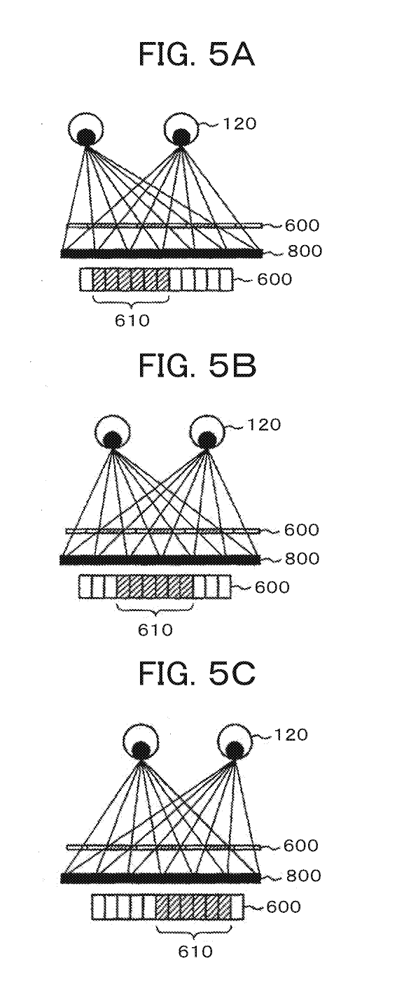

FIGS. 5A, 5B, and 5C are pattern diagrams showing that the barrier pattern 600 is moved in accordance with movement of the human eyes 120 so as to avoid the cross talk between the pixels for the right eye and the pixels for the left eye. In FIGS. 5A through 5C, the human eyes 120 view a pixel pattern 800 via the barrier pattern 600, and thus the human being can recognize a three-dimensional image. FIGS. 5A to 5C show that the human eyes move from the right to the left with respect to the paper surface. Strip patterns at lowest areas of FIGS. 5A to 5C each show that the barrier region 610 of the barrier pattern 600 moves from the left to the right. This can prevent the cross talk between the pixels for the right eye and the pixels for the left eye.

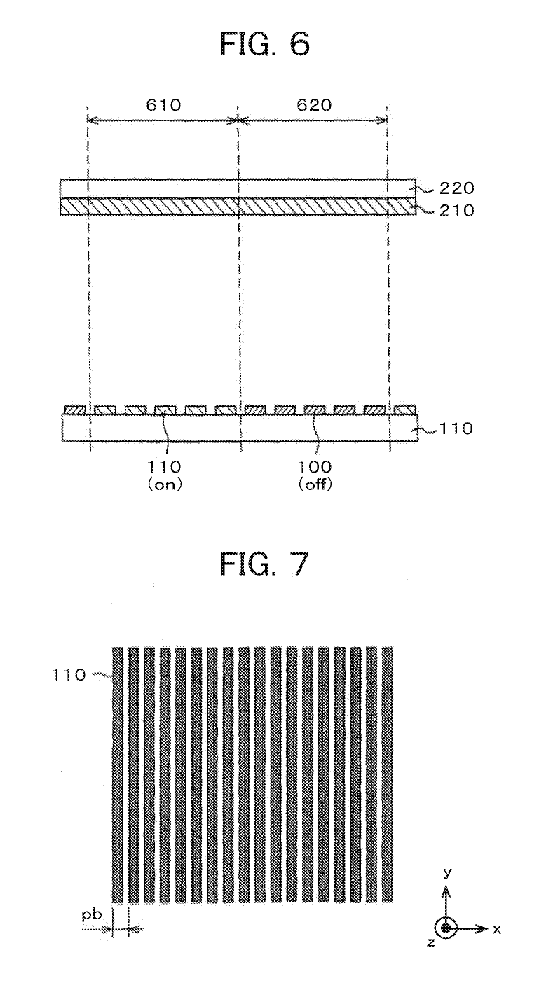

FIG. 6 shows an electrode structure for moving the barrier pattern 600 in the parallax barrier panel. FIG. 6 is equal to the conventional case in that the common electrode 210 is formed on the common substrate 200 in a plane state. On the other hand, the barrier electrodes 110 on the barrier substrate 100 are in a stripe form extending in the direction perpendicular to the paper surface, but a pitch of the barrier electrodes is smaller than a pitch of the barrier pattern. In FIG. 6, the barrier region is formed by turning on the five barrier electrodes 110, and the opening region 620 is formed in correspondence with the five barrier electrodes 110 in an OFF state. To move a position of the barrier region 610, the barrier electrode 110 on one side of the barrier region 610 may be turned off and the barrier electrode 110 on the other side of the barrier region 610 may be turned on.

As described above, forming the barrier region 610 with the plurality of barrier electrodes 110 can move the position of the barrier region 610, permitting accurate performance of feedback achieved through eye tracking.

In FIG. 6, the barrier region 610 is formed in a region where the barrier electrodes 110 are ON, and the transmission region 620 region is formed in a region where the barrier electrodes 110 are OFF. Moreover, a state in which the barrier electrodes 110 are ON is a state in which voltage is applied to the barrier electrodes 110.

FIG. 7 is a plan diagram of the barrier electrodes 110 on the barrier substrate 100 of FIG. 6. In FIG. 7, the barrier electrodes 110 are stripe-shaped, and are arrayed at pitches of pb in an x-direction.

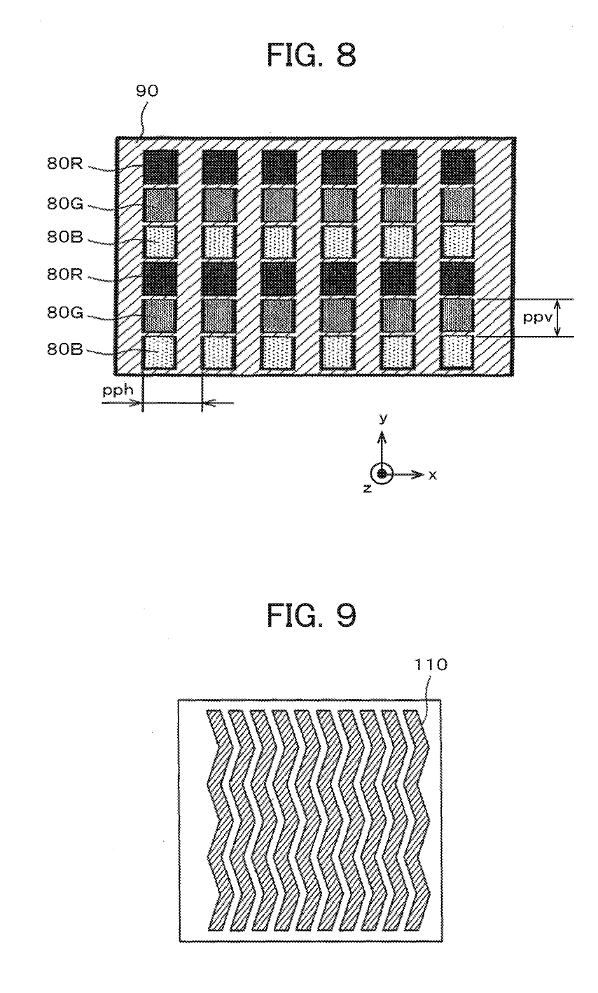

FIG. 8 is a plan diagram showing pixel arrangement on the liquid crystal display panel. The red pixels 80R, the green pixels 80G, and the blue pixels 80 B are arrayed at pitches of ppv in a vertical direction y. Here, the pitch pph of the pixels in the x-direction is greater than the pitch pb of the barrier electrodes 110 in the x-direction, providing relationship ppb>2pb. An area between every two pixels, a black matrix 90 is filled. This improves the screen contrast.

In FIG. 7, the barrier electrode 110 is formed by a transparent electrode of, for example, ITO, and this transparent electrode has predetermined transmittance, thus creating, on the barrier substrate 100, bright and dark portions in a stripe form by the pitches pb. On the other hand, created on a liquid crystal display panel side by the black matrix 90 are bright and dark portions in a stripe form. Therefore, even in case of two-dimensional display in which no voltage is applied to the barrier substrate 100, moire appears on the screen as a result of interference between the barrier electrodes 110 and the black matrix 90. The moire deteriorates image quality.

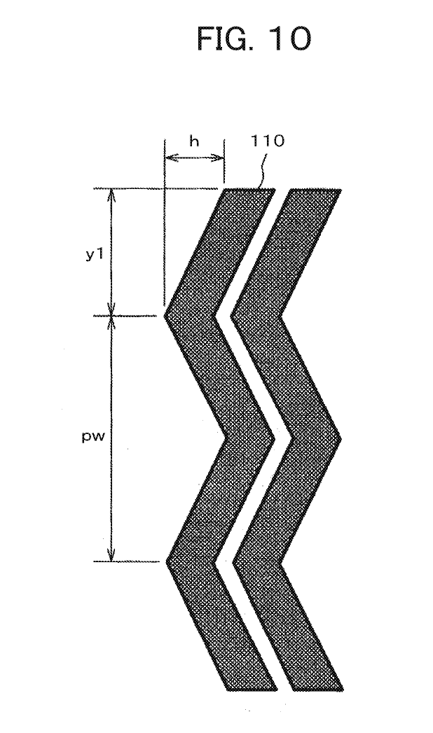

FIG. 9 is a plan diagram showing an example of the barrier electrodes 110 according to the invention for taking countermeasures against the moire. In FIG. 9, the barrier electrodes 110 extend in the first direction (vertical direction) while bending in the second direction (horizontal direction) and a direction opposite to the second direction, and are arrayed at predetermined pitches in the second direction (horizontal direction). FIG. 10 is a detailed plan diagram of the barrier electrode shown in FIG. 9. In FIG. 10, a bending pitch of the barrier electrode 110 is pw, and a bending height, that is, a wave height is h.

A degree of the moire varies depending on the bending pitch pw and the bending height h. Moreover, the moire becomes more conspicuous as it becomes increasingly away from the screen. It is assumed that a distance at which the mobile phone or the like is viewed is within 40 cm from the screen, and thus it can be assumed that the moire problem has been resolved if no moire appears within 40 cm from the screen.

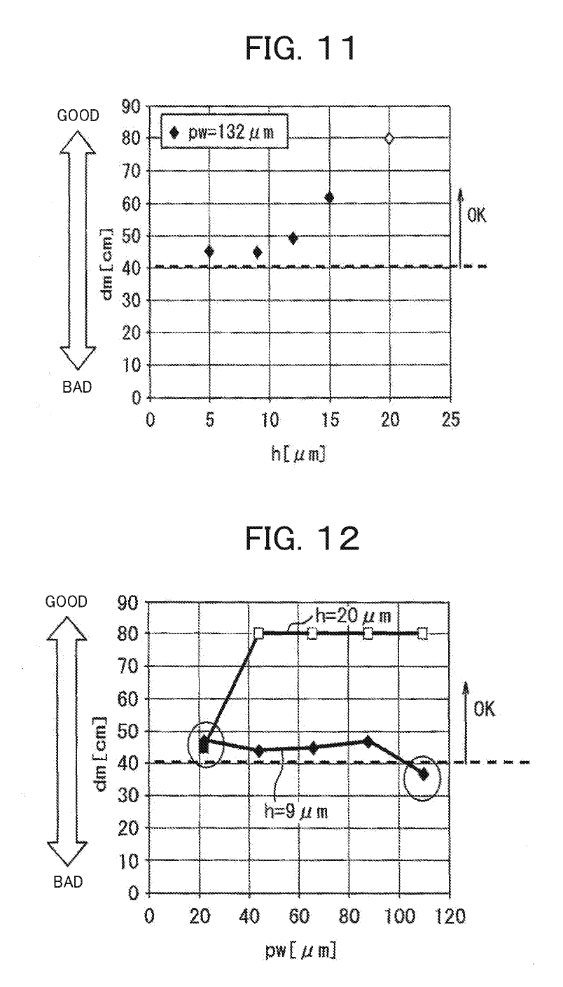

FIG. 11 is a plot of a distance dm from the screen where the moire is recognized in a case where the bending pitch pw of the barrier electrode 110 in FIG. 10 is fixed at 132 μm and the bending height, that is, the wave height h is varied. In FIG. 11, if the bending height h is 5 μm, the distance dm from the screen at which the moire starts to appear is 45 cm. If the bending height h is 15 μm, the distance dm from the screen at which the moire starts to appear is 62 cm. If the bending height h is 20 μm, no moire appears even if the distance dm from the screen exceeds 80 cm. A void diamond shape in FIG. 11 shows that no moire is viewed.

FIG. 12 is a plot of the distance dm from the screen at which the moire is recognized in a case where the bending height h of the barrier electrode in FIG. 10 is fixed and the bending pitch pw is varied. In FIG. 12, if the bending height h is 9 μm, where the bending pitch pw is 22 μm, the distance dm from the screen at which the moire starts to appear is 48 cm. Up to bending pitches pw of 100 μm, the distance dm from the screen at which the moire starts to appear is kept at 40 cm or more. However, if the bending pitch pw reaches 110 μm, the distance dm from the screen at which the moire starts to appear is 38 cm, which falls below 40 cm.

In FIG. 12, if the bending height h is 20 μm, where the bending pitch pw is 22 μm, the distance dm from the screen at which the moire starts to appear is 45 cm. Excess of the bending pitch over 43 μm results in no appearance of moire even over 80 cm. In FIG. 12, a void □ means that the moire does not appear even when the distance from the screen exceeds 80 cm.

Based on assumption from FIGS. 11 and 12, it can be said that moire appearance within a visual distance of 40 cm can be suppressed if the bending pitch pw is between 20 μm and 132 μm both inclusive and the wave height value h is between 5 μm and 20 μm both inclusive.

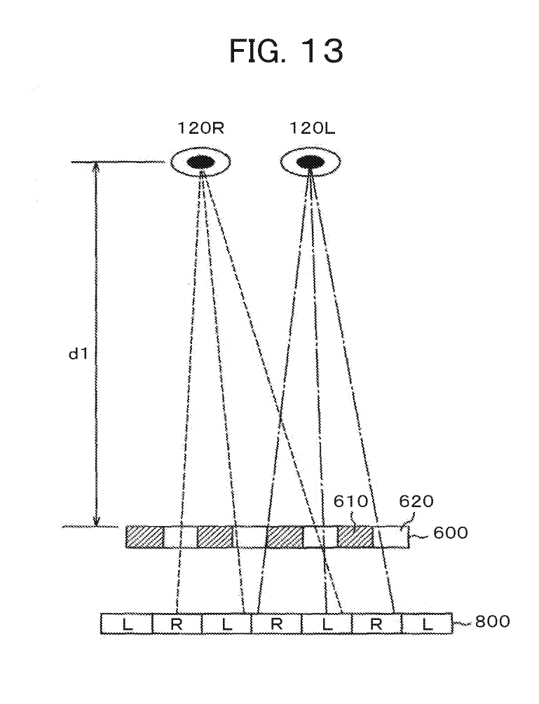

As described above, countermeasures against the moire can be taken by providing the barrier electrodes 110 with a bending pattern. However, providing the barrier electrodes 110 with the bending pattern raises another problem. FIG. 13 is a pattern diagram showing this problem. FIG. 13 is a view in a case where a position at which a three-dimensional image is viewed by the parallax barrier is d1 which is made larger than a proper position. That is, in comparison with d in FIG. 2, d1>d is provided.

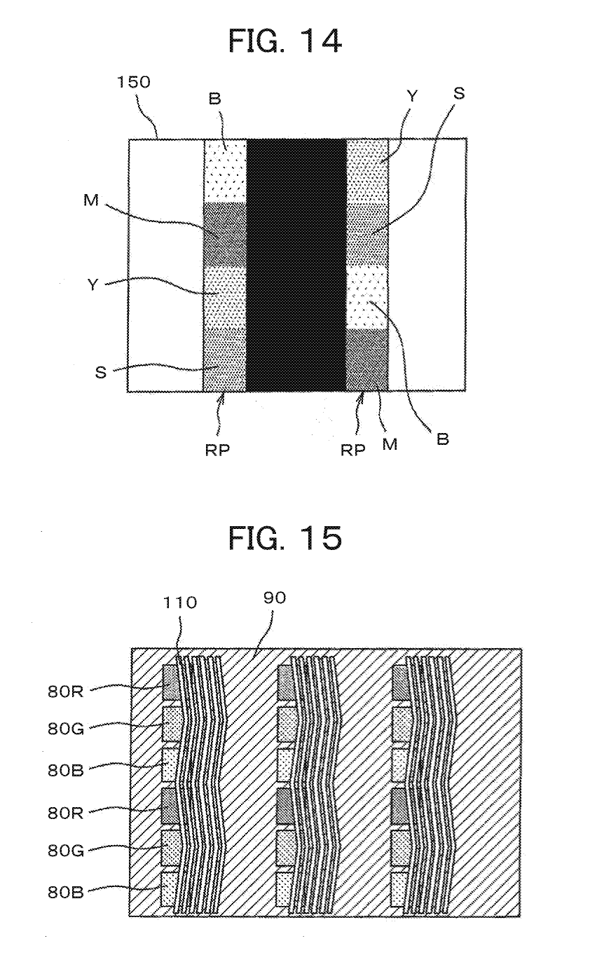

FIG. 13 shows that part of the pixels originally supposed to be viewed with only the right eye is also viewed with the left eye and part of the pixels originally supposed to be viewed with only the left eye is also viewed with the right eye. This raises a problem as shown in FIG. 14. In display with the left eye (white display) and the right eye (black display) or in display with the left eye (black display) and the right eye (white display), a black pattern near a center is a black display part, and white patterns on both sides thereof are viewed as white display parts. In FIG. 14, near the center, a black pattern BLACK appears, and on both sides thereof, white patterns WHITE appear. Then on both sides of the black pattern, rainbow patterns of yellow Y, cyan S, blue B, magenta M, etc. appear. This pattern considerably deteriorates screen impression.

The rainbow pattern shown in FIG. 14 is assumed to appear, for example, in case of arrangement as shown in FIG. 15. In FIG. 15, a barrier region is formed with the six barrier electrodes 110. In the opening region, the red pixels 80R, the green pixels 80G, and the blue pixels 80B are visible. In FIG. 15, an area of the green pixels 80G is largest. That is, in this case, a green color is dominant on the both sides of the black pattern.

In FIG. 15, the bending pitch of the barrier electrode 110 agrees with a total pitch of the red pixel 80R, the green pixel 80G, and the blue pixel 80B, but in a case where the bending pitch of the barrier electrode 110 does not agree with the total pitch of the red pixel 80R, the green pixel 80G, and the blue pixel 80B, the rainbow pattern RP as shown in FIG. 14 appears on the both sides of the black pattern.

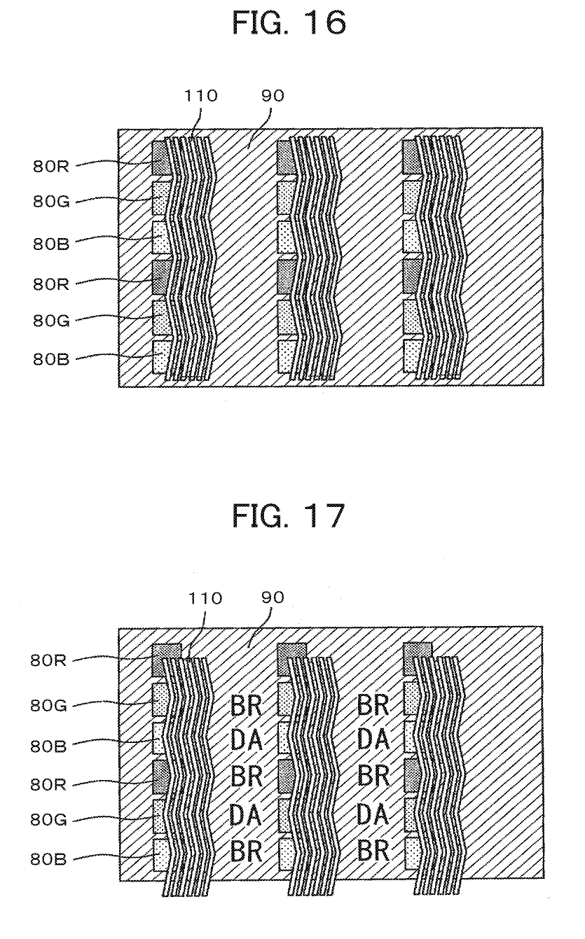

To suppress the rainbow pattern RP as shown in FIG. 14, it is possible to provide relationship between the barrier electrode 110 and the pixels 80R, 80G, and 80B as shown in FIG. 16. In FIG. 16, the bending pitch pw of the barrier electrode 110 agrees with a vertical pitch of the two pixels. As shown in FIG. 16, an area of the opening is identical for all the pixels.

However, FIG. 16 shows a case where the pixels and also the barrier electrodes are arranged completely in accordance with designed values. Practically, the pixels and the barrier electrodes are so formed as to be deviant from the designed values within tolerance in some cases, and positioning between the barrier panel 1000 and the liquid crystal display panel 3000 shifts in some cases. In particular, the shift in the positioning between the barrier panel 1000 and the liquid crystal display panel 3000 has a great influence.

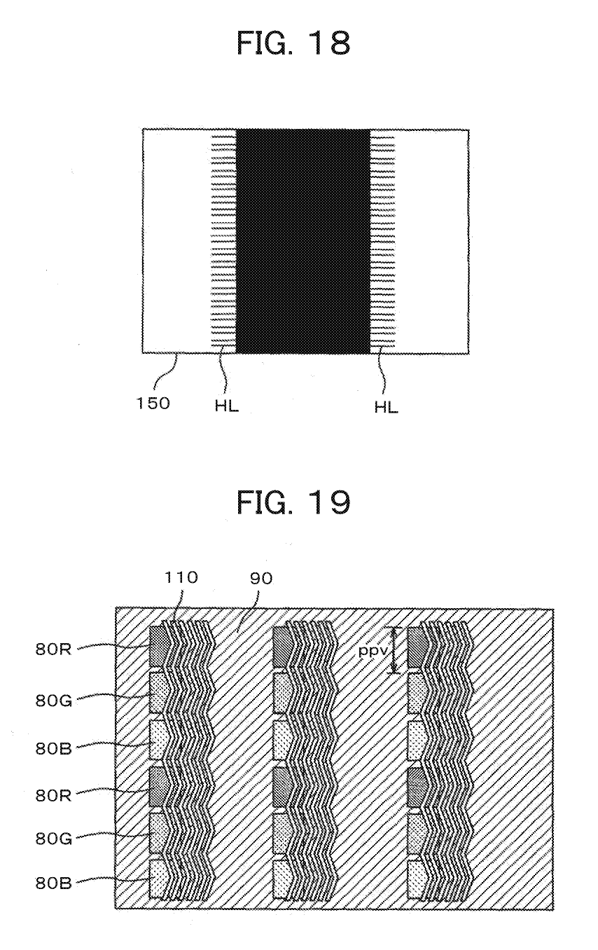

FIG. 17 is a plan view in a case where the barrier electrodes 110 are vertically shifted with respect to the pixels 80R, 80G, and 80B. In FIG. 17, an area of the opening part, which is not blocked by the barrier, is large and small alternately on an individual pixel basis. That is, a bright portion BR and a dark portion D are repeated on an individual pixel basis. As a result, the dark portion is viewed in a line, causing a horizontally-lined pattern HL as shown in FIG. 18. The appearance of such an HL also considerably deteriorate the screen impression.

FIG. 19 is a plan diagram showing the parallax barrier according to the invention. In FIG. 19, the bending pitch pw of the barrier electrode 110 corresponds to a vertical pitch of one pixel. As shown in FIG. 19, an area of the opening part not blocked by the barrier is equal to that of each of the red pixel 80R, the green pixel 80G, and the blue pixel 80B. Therefore, the rainbow pattern RP as shown in FIG. 14 does not appear.

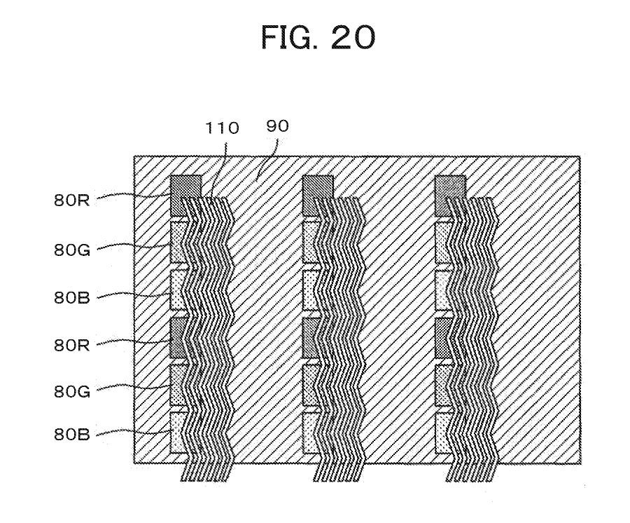

FIG. 20 shows a case where the barrier electrode 110 is vertically shifted by half of the vertical pitch of the pixel. Even in this case, an area of the opening part not blocked by the barrier is identical for all the red pixels 80R, the green pixels 80G, and the blue pixels 80B. Therefore, a horizontally-lined pattern HL as shown in FIG. 18 does not appear.

The invention is not limited to a case where the bending pitch pw of the barrier electrode 110 as shown in FIG. 19 corresponds to the vertical pitch of one pixel. That is, where the bending pitch of the barrier electrode 110 is pw and the vertical pitch of the pixel is ppv, similar effect is also provided in a case where npv (where n is an integer number) is relevant.

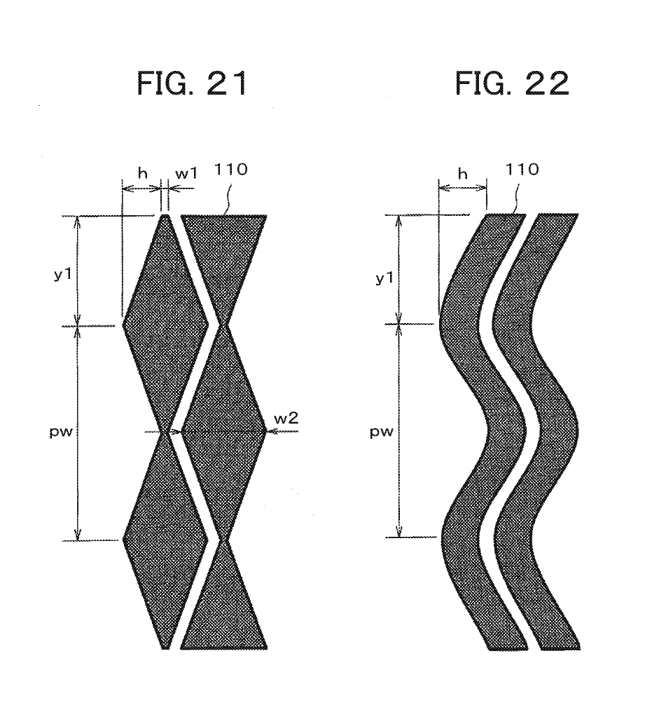

It is described above that the barrier electrode 110 is a bending pattern obtained by bending a stripe as shown in FIG. 10, but the barrier electrode 110 is not limited to this, and it may have configuration as shown in FIG. 21 such that hexagons with a short length w of opposing two sides are vertically linked together. Alternatively, a shape of FIG. 21 can be defined as a pattern such that a shape obtained by linearly linking together a narrow portion with a width w1 and a wide portion with a width w2 is repeated. The bending pitch pw in this case is a distance between summits of the wide portions, and thus the bending height, that is, the wave height h can be defined as (w1−w2)/2.

Moreover, the barrier electrode may be a wavy pattern as shown in FIG. 22. The bending pitch pw in this case can be defined as a distance between summits of the wave as shown in FIG. 22, and the bending height h can be defined as a wave height.

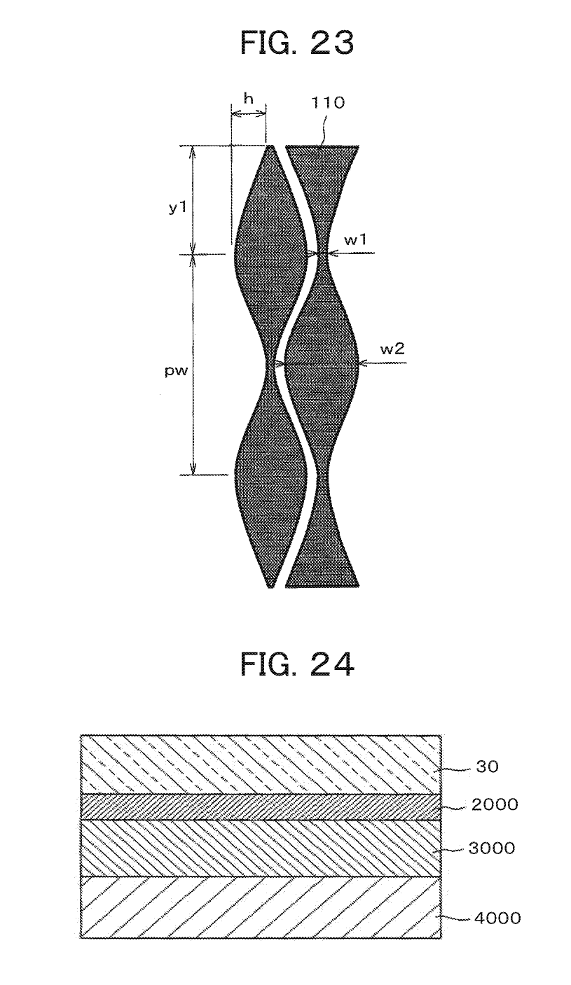

Further, the barrier electrode can be provided with a pattern such that a shape obtained by connecting together with a curve a narrow portion with a width w1 and a wide portion with a width w2 is repeated like sand clocks as shown in FIG. 23 are vertically linked together. The bending pitch pw in this case can be defined as a distance between summits of a wave, as shown in FIG. 23, and the bending height, that is, the wave height h can be defined as (w2−w1)/2.

In FIGS. 10, 21, 22, and 23, a vertical length from a valley (first bending point) to a summit (second bending point) is y1. In FIGS. 10, 21, 22, and 23, relationship y1=pw/2 is provided, but the invention is not limited to this, and the effects of the invention can also be provided where y1<pw/2 or y1>pw/2.

### Second Embodiment

This embodiment refers to a case where the invention is applied to a three-dimensional display device using a liquid crystal lens. FIG. 24 is a schematic sectional view of the three-dimensional image display device using the liquid crystal lens 100. In FIG. 24, a liquid crystal lens panel 30 and a liquid crystal display panel 3000 are bonded together with a bonding material 2000. The bonding material 2000 is transparent, and uses, for example, UV (ultraviolet) cured resin. Arranged on a rear surface of the liquid crystal display panel 3000 is a back light 4000.

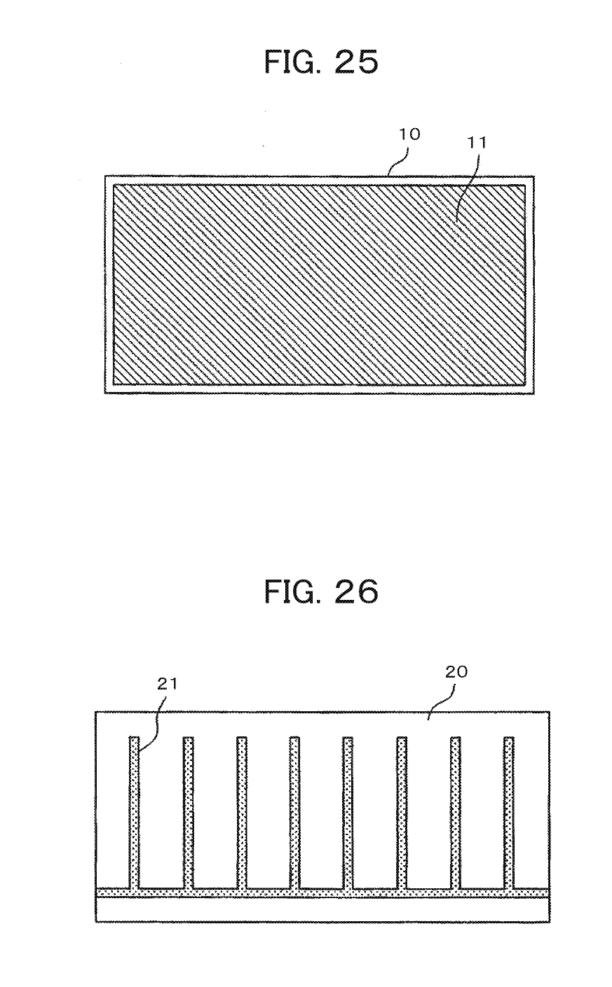

The liquid crystal lens panel 30 is so configured as to sandwich liquid crystal between a first substrate 10 and a second substrate 20. FIG. 25 is a plan diagram of the first substrate 10. In FIG. 25, an entire surface of a display region of the first substrate 10 is covered in a plane form by a first electrode 11. FIG. 26 is a plan diagram of the second substrate 20. Formed on the second substrate 20 are second electrodes 21 in a sinking comb form whose one end is connected by a bus electrode.

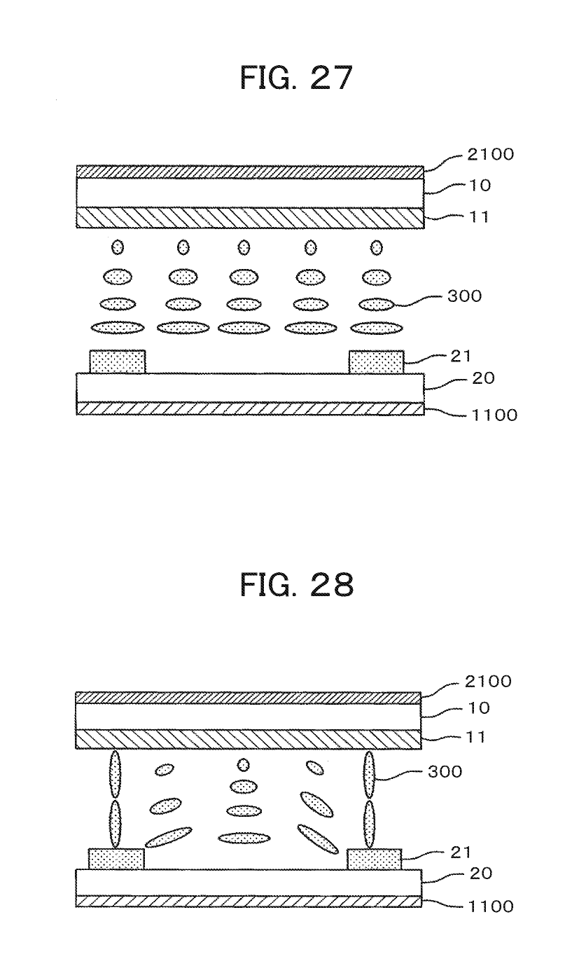

FIGS. 27 and 28 are sectional diagrams showing a structure of the liquid crystal lens. Formed on the first substrate 10 is the first electrode 11 in a plane state, and formed on the second substrate 20 is the second electrodes 21 extending in a direction perpendicular to the paper surface. Between the first substrate 10 and the second substrate 20, liquid crystal 300 is sandwiched. Attached to outside of the first substrate 10 is an upper polarizing plate 2100, and attached to outside of the second substrate 20 is a lower polarizing plate 1100. This configuration also applies to FIG. 28.

FIG. 27 shows a state in which no voltage is applied to the second electrode 21 and the first electrode 11 and no liquid crystal lens is formed. At this point, a two-dimensional image is displayed. FIG. 28 shows a state in which voltage is applied to the second electrode 21 and the first electrode 11 and liquid crystal molecules are oriented in accordance with a formed electric power line as shown in FIG. 28. Depending on anisotropy of a refractive index of the liquid crystal 300, the lenses are formed. At this point, a three-dimensional image is formed.

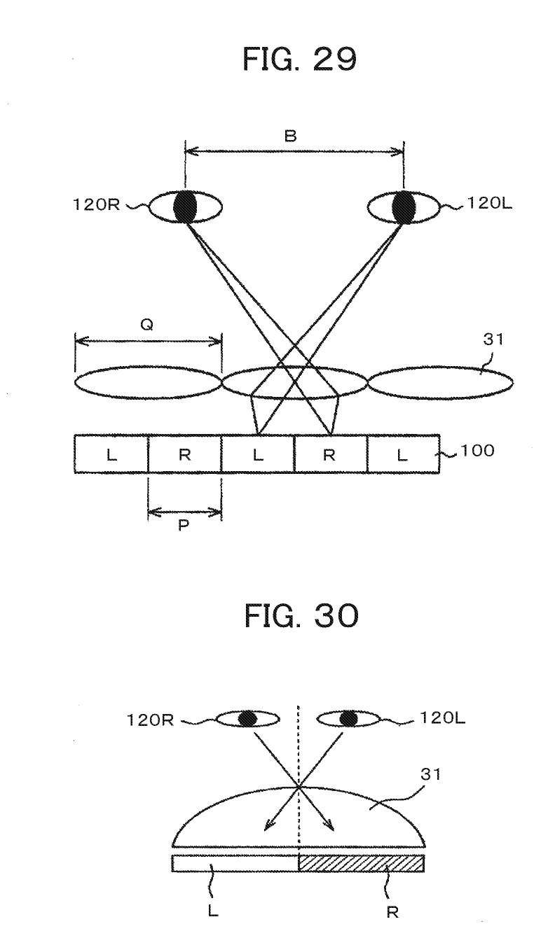

FIG. 29 is a sectional diagram showing principles of forming a three-dimensional image by using liquid crystal lenses 31. In FIG. 13, the human eyes 120R and 120L view the image formed in the liquid crystal display device 1000 through the liquid crystal lenses 31. In FIG. 29, pixels for the right eye 120R are R, and pixels for the left eye 120L are L. A pitch of the liquid crystal lens 31 in FIG. 29 is Q, and a pixel pitch of the display device 1000 is P. Moreover, a distance between a center of the human left eye and a center of the right eye, that is, an interocular distance is B. Generally, the interocular distance B is supposed to be 65 mm Relationship among the pitch Q of the liquid crystal lens, the pixel pitch P of the display device, and the interocular distance B is as shown in (Formula 1).

$$\begin{matrix}[ Formula 1 ] & \\ Q = \frac{2 P}{( 1 + P / B )} & ( 1 )\end{matrix}$$

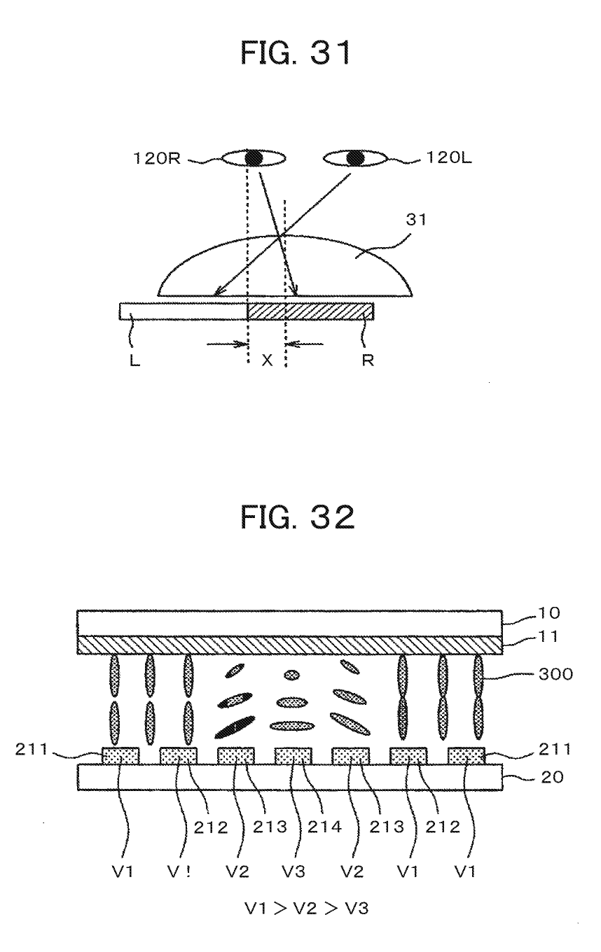

FIG. 30 is a pattern diagram simply expressing three-dimensional display in a liquid crystal lens system. In FIG. 30, the liquid crystal lens 31 is expressed as a semicircular lens. As shown in FIG. 31, the three-dimensional display in the liquid crystal lens system is based on assumption that the human eyes are fixed at predetermined positions for viewing.

FIG. 31 shows a case where the human eyes shift rightward of the paper surface by an amount of x. If a position of the liquid crystal lens 31 is at an original position as shown in FIG. 30, the pixels R that can originally be recognized with only the right eye can also be recognized with the left eye and the pixels L that can originally be recognized with only the right eye can also be recognized with the left eye, deteriorating quality of the three-dimensional image. FIG. 31 prevents such a problem by also moving the liquid crystal lens 31 in accordance with movement of the human eyes.

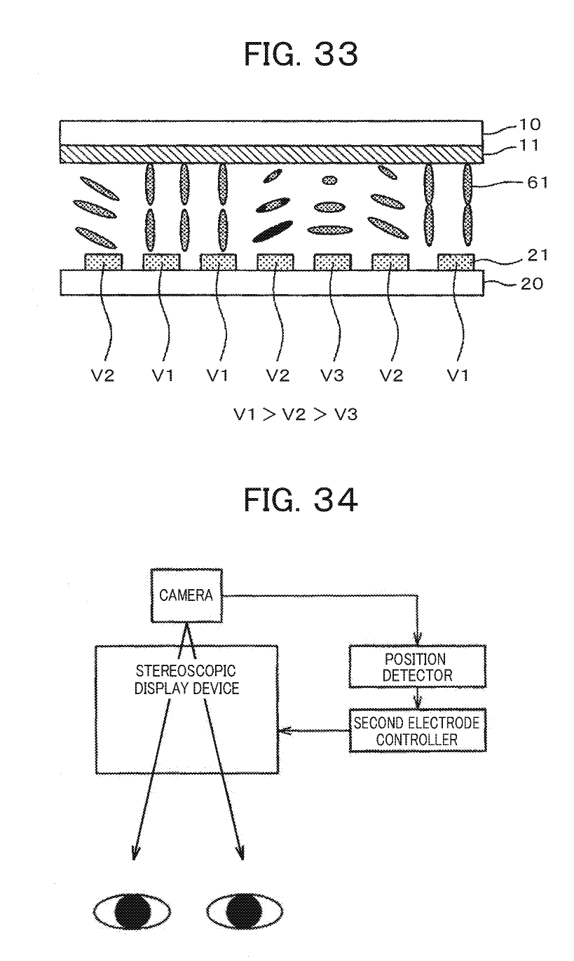

FIGS. 32 and 33 are sectional diagrams showing configuration of the liquid crystal lens 31 capable of moving its position as shown in FIG. 31. In FIG. 32, the first electrode 11 is formed on the first substrate 10 in a plane state. Formed on the second substrate 20 are a plurality of (exceeding two) second electrodes 211 within one liquid crystal lens, forming a so-called multi-electrode. The second electrode 211 extends in a stripe form in the direction perpendicular to the paper surface, and different voltage can be applied to each second electrode 211.

In FIG. 32, the second electrode 211 arranged on an outermost side forms a boundary between the lenses. In FIG. 32, the voltages V1, V2, and V3 applied to the second electrodes are provided in a manner such as to achieve V1>V2>V3. Varying the voltages applied to the second electrodes 211, 212, 213, and 214 can change a position at which the lens is formed. FIG. 33 shows an example in which the position of the liquid crystal lens is shifted rightward by varying the voltage applied to each second electrode 21.

In FIGS. 32 and 33, where a pitch of the second electrodes 211, 212, etc. is pb and a pixel pitch in the same direction is pph, pph>ppb, which is the same as is the case with the parallax barrier.

FIG. 34 is a pattern diagram showing an eye-tracking system in the liquid crystal lens system. Specifically, FIG. 34 is a block diagram showing a system of tracking movement of a line of sight with a camera and then feeding this data back to the display device. In FIG. 34, position of the human eyes are detected with the camera. For this camera, for example, a photographic camera in, for example, a mobile phone can be used without using a dedicated camera to apply this system.

In FIG. 34, the position of the human eyes detected with the camera is inputted to a position detector, from which this signal is inputted to a second electrode controller. The second electrode controller generates a signal controlling voltage of the plurality of second electrodes on the second substrate of a liquid crystal lens cell. Then the voltage applied to the second electrode is controlled to thereby control the position of the liquid crystal lens.

The second electrode of a stripe shape as shown in FIGS. 32 and 33 is formed with a transparent electrode of, for example, the ITO, but even the transparent electrode has predetermined transmittance and thus causes a moire problem as is the case with the parallax barrier. Also in case of the liquid crystal lens, countermeasures against the moire can be taken by providing the second electrode 21 with a bending pattern, but problems such as appearance of a rainbow pattern as shown in FIG. 14 and appearance of a linear pattern as shown in FIG. 18 also occur in case of the liquid crystal lens system.

Such problems are caused for the same reason as for the parallax barrier system, and thus as is the case with the parallax barrier, as shown in FIGS. 19 and 20, countermeasures can be taken by providing, where the second electrode 21 is provided with a bending pattern, a bending pitch is pw, and a vertical pitch of pixels is ppv, npw (n is an integer number) for ppv. Moreover, relationship among the bending pitch pw, a bending height or a wave height h, and the moire is similar to that shown in FIGS. 11 and 12.

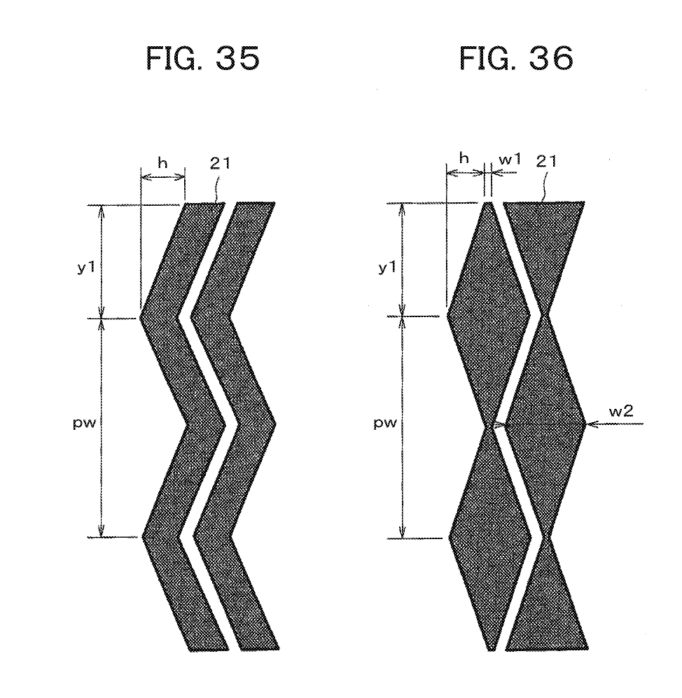

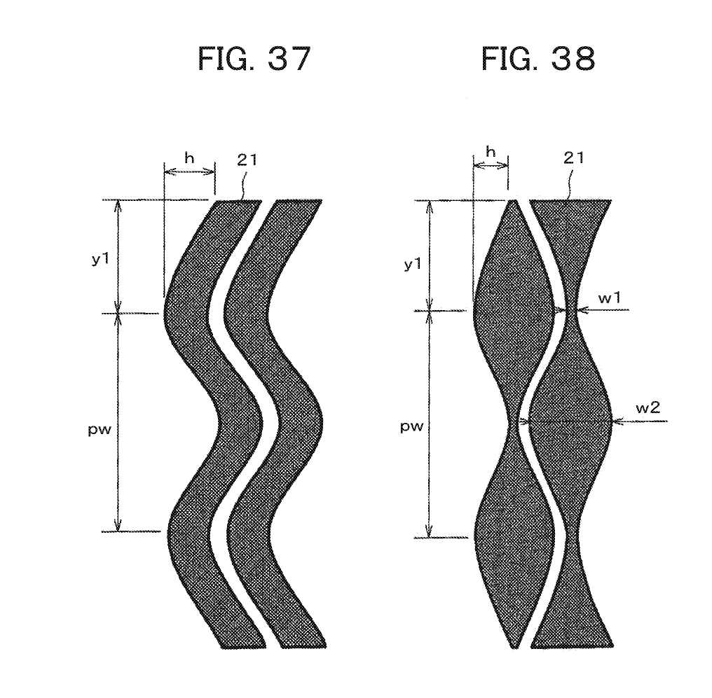

FIGS. 35, 36, 37, and 38 show examples of the second electrode 21 in the liquid crystal lens. They respectively correspond to FIGS. 10, 21, 22, and 23 in the parallax barrier system. Specifically, FIGS. 35, 36, 37, and 38 replace the barrier electrodes 110 in FIGS. 10, 21, 22, and 23 with the second electrodes 21 of the liquid crystal lens. Forming the second electrode 21 into shapes as in FIGS. 35, 36, 37, and 38 result in different lens shapes formed, making it possible to form a three-dimensional image. Moreover, in FIGS. 35, 36, 37, and 38, a vertical length from a valley (first bending point) to a summit (second bending point) is y1. In FIGS. 35, 36, 37, and 38, relationship y1=pw/2 is provided, but the invention is not limited to this, and even in case of y1<pw/2 or y1>pw/2, the effects of the invention can be provided.

In the description above, vertically arrayed on the display panel are the three pixels of the different colors, but the invention is applicable not only to such pixel configuration but also to a case where pixels of a single color are vertically arrayed, a case where pixels of two different colors are vertically arrayed, and a case where pixels of four or more different colors are vertically arrayed.

Moreover, in the description above, the display device is the liquid crystal display device, but the invention is not limited to this and is also applicable to a case where the display device is, for example, an organic EL display device or a field emission display (FED).

What is claimed is:

1. A display device having a liquid crystal parallax barrier panel arranged on a display panel,
wherein pixels are arrayed at a pitch p1 in a first direction and are arrayed at a pitch p2 in a second direction on the display panel,
the parallax barrier is configured such that liquid crystal is sandwiched between a first substrate on which an electrode is formed in a plane state and a second substrate on which barrier electrodes extending in the first direction and arrayed at a pitch p3 in the second direction are formed,
p2>2p3,
the barrier electrode extends in the first direction while repeatedly bending at a wave height h and a pitch pw, and
with respect to a first pitch p1 of the pixels, a pitch of the barrier electrodes corresponds in terms of npw (n is an integer number).

2. The display device according to claim 1,
wherein the h is equal to or more than 20 μm, and the pw is equal to or less than 100 μm.

3. The display device according to claim 1,
wherein the h is between 5 μm and 20 μm both inclusive, and the pw is between 20 μm and 132 μm both inclusive.

4. The display device according to claim 1, wherein the barrier electrode is obtained by linearly bending a stripe-shaped electrode.

5. The display device according to claim 1, wherein the barrier electrode is obtained by bending a stripe-shaped electrode in a curve.

6. The display device according to claim 1, wherein the barrier electrode has a shape so formed as to repeat a narrow portion and a wide portion, and the shape is obtained by linking together the narrowest portion and the widest portion with a straight line.

7. The display device according to claim 1, wherein the barrier electrode has a shape repeating a narrow portion and a wide portion, and the shape is obtained by linking together the narrowest portion and the widest portion with a curve.

8. A display device having a liquid crystal lens arranged on a display panel,
wherein pixels are arrayed at a pitch p1 in a first direction and are arrayed at a pitch p2 in a second direction on the display panel,
the liquid crystal lens is configured such that liquid crystal is sandwiched between a first substrate on which a first electrode is formed in a plane state and a second substrate on which second electrodes extending in the first direction and arrayed at a pitch p3 in the second direction are formed,
p2>2p3,
the second electrode extends in the first direction while repeatedly bending at a wave height h and a pitch pw, and
with respect to a first pitch p1 of the pixels, a pitch of the second electrodes corresponds in terms of npw (n is an integer number).

9. The display device according to claim 8, wherein the h is equal to or more than 20 μm, and the pw is equal to or less than 100 μm.

10. The display device according to claim 8, wherein the h is between 5 μm and 20 μm both inclusive, and the pw is between 20 μm and 132 μm both inclusive.

11. The display device according to claim 8, wherein the second electrode is obtained by linearly bending a stripe-shaped electrode.

12. The display device according to claim 8, wherein the second electrode is obtained by bending a stripe-shaped electrode in a curve.

13. The display device according to claim 8, wherein the second electrode has a shape so formed as to repeat a narrow portion and a wide portion, and the shape is obtained by linking together the narrowest portion and the widest portion with a straight line.

14. The display device according to claim 8, wherein the second electrode has a shape repeating a narrow portion and a wide portion, and the shape is obtained by linking together the narrowest portion and the widest portion with a curve.
